(19) United States
(12) Patent Application Publication
(10) Pub. No.: US 2025/0153992 A1
(43) Pub. Date: May 15, 2025

(54) FOOD CAN TAB EXTENDER WITH SCORED LID REMOVER

(71) Applicants: Cara E. Weber, Branford, CT (US); David A. Stepper, Branford, CT (US); Charles E. Weber, JR., Branford, CT (US)

(72) Inventors: Cara E. Weber, Branford, CT (US); David A. Stepper, Branford, CT (US); Charles E. Weber, JR., Branford, CT (US)

(21) Appl. No.: 18/941,874

(22) Filed: Nov. 8, 2024

Related U.S. Application Data
(60) Provisional application No. 63/597,515, filed on Nov. 9, 2023.

(51) Int. Cl. B67B 7/40

(52) U.S. Cl. CPC B67B 7/403

(57) ABSTRACT

A device for removing a scored portion of a lid from a food can. The device includes a circular disk having a disk edge and a tab slot for engaging a lid tab disposed on the lid when the lid tab is in an extended position and a cylindrical wall extending perpendicular from the disk edge, the cylindrical wall for engaging a food can rim. The device included a wedge disposed on a portion of the circular disk along the cylindrical wall, the wedge for rotating a lid tab distal end away from a scored portion of lid of a food can and a magnet for removably securing the scored lid to the circular disk. The wedge may be integrated with the cylindrical wall. The circular disk has a perimeter extending beyond the cylindrical wall.

### CROSS-REFERENCE TO RELATED APPLICATIONS

This application is a Utility Patent application claiming priority to U.S. Provisional Patent Application Ser. No. 63/597,515, filed on Nov. 9, 2024, which is incorporated by reference herein in its entirety.

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates in general to the field of can openers, and more particularly, to a device designed for safely and conveniently opening cans that have a top lid portion removable with a pull tab.

### 2) Description of Related Art

In food and beverage consumption, canned goods play a significant role. These goods are typically sealed with a lid that includes a pop top or pull tab for easy opening. However, opening these cans can sometimes be a challenging task. The pull tab tension on cans is often strong, making them hard to maneuver. The pull tabs are often small and difficult to grip, especially for individuals with limited hand strength or dexterity, such as the elderly or those with certain physical disabilities. There are sharp edges around the lid circumference that pose safety concerns when removing a lid and disposing of it. Additionally, the process of opening the can may result in splattering of the can's contents, leading to potential mess and waste. Therefore, there is a general need for improved methods and tools to facilitate the opening of canned goods in a safe and efficient manner.

Food cans are a common packaging method for preserving and storing various food products. These cans typically feature a circular lid with a scored portion designed for easy opening. Traditional can openers, while effective, can be cumbersome to use and may pose safety risks due to sharp edges. In recent years, manufacturers have introduced pull-tab lids to simplify the opening process for consumers.

Despite these advancements, opening food cans can still present challenges for some individuals, particularly those with limited hand strength or dexterity. The pull-tab mechanism, while convenient, may sometimes be difficult to grip or manipulate. Additionally, removing the entire lid can be problematic, as it may come into contact with the food contents or create sharp edges that pose safety concerns.

There is a general need for improved tools and methods for opening food cans that address these challenges. Ideally, such solutions would provide a safe, easy-to-use mechanism for removing scored portions of can lids while minimizing the risk of injury or contamination. Furthermore, a device that could assist in the disposal of the removed lid portion would be beneficial for both convenience and safety reasons.

As the food packaging industry continues to evolve, there is an ongoing interest in developing innovative tools that enhance the consumer experience while maintaining food safety standards. Improvements in can-opening technology have the potential to benefit a wide range of users, from individuals with physical limitations to those seeking more efficient ways to access canned food products.

These and other objects, features, and advantages of the present invention will become more readily apparent from the attached drawings and the detailed description of the preferred embodiments, which follow.

### BRIEF SUMMARY OF THE INVENTION

Bearing in mind the problems and deficiencies of the prior art, it is therefore an object of the present invention to provide a device for removing a scored portion of a lid of a food can.

According to an aspect of the present disclosure, a device for removing a scored portion of a lid of a food can is provided. The device includes a circular disk having a disk edge and a tab slot for engaging a lid tab disposed on the lid when the lid tab is in an extended position. The device also includes a cylindrical wall extending perpendicular from the disk edge, the cylindrical wall for engaging a food can rim. The device further includes a wedge disposed on a portion of the circular disk along the cylindrical wall, the wedge for rotating a lid tab distal end away from a scored portion of lid of a food can. Additionally, the device includes a magnet on the circular disk for removably securing the scored lid to the circular disk. The size of the tab slot may be designed to allow for easy insertion and removal of the lid tab while providing sufficient engagement to effectively manipulate the tab during the opening process. In some aspects, the edges of the tab slot may be smoothed or rounded to prevent snagging or damage to the lid tab during use. The height of the cylindrical wall may vary in different aspects of the device. In some cases, the cylindrical wall may be relatively short, extending just enough to securely engage with the can rim. In other implementations, the cylindrical wall may be taller, potentially providing additional stability or serving other functions related to the lid removal process. The wedge may be integrated with the cylindrical wall.

The positioning of the magnet on the circular disk may also vary in different implementations of the device. In some cases, the magnet may be centrally located on the circular disk, providing a balanced attachment point for the removed lid. In other aspects, the magnet may be positioned off-center or near the edge of the circular disk. This variation in magnet placement may allow for different lid removal techniques or accommodate various can sizes. The magnet may be positioned centrally on the circular disk. The strength and size of the magnet may also be varied to suit different applications. In some implementations, a single strong magnet may be used, while in others, multiple smaller magnets may be arranged in a pattern across the circular disk. The magnetic strength may be tailored to provide sufficient holding power for the lid while still allowing for easy separation when desired. The magnet may be incorporated into the device in various ways. The method of integration may influence factors such as the magnet's effectiveness, protection from environmental elements, and ease of cleaning. In certain implementations, the magnet may be encapsulated within the material of the circular disk. This encapsulation may occur from the top of the circular disk, with the magnet embedded beneath a layer of the disk material. Alternatively, the magnet may be encapsulated from the underside of the circular disk, potentially allowing for a smoother top surface. Encapsulation may provide protection for the magnet, preventing direct contact with food or liquids and potentially extending the lifespan of the magnetic component.

In other cases, the magnet may be partially exposed on the surface of the circular disk. This partial exposure may allow for stronger magnetic attraction to the can lid, as there may be less intervening material between the magnet and the metal lid. The degree of exposure may vary, potentially influencing the balance between magnetic strength and protection of the magnet. The circular disk may be flat or concave. The magnet may be encapsulated from the top or the underside of the circular disk. The magnet may be partially exposed. The device material may be plastic, nylon, silicone, rubber or any combination thereof. The device material may be food safe. The device may include ribs for strengthening a connection between the circular disk and the cylindrical wall. The tab slot may be an ellipsis, a square or rectangle. The wedge may be a lifting feature section that has a slope that tapers from thin front edge to back edge.

In some aspects, the shape of the circular disk may vary. The circular disk may be flat in certain implementations, providing a planar surface that covers the food can lid. A flat circular disk may offer simplicity in design and manufacturing, potentially allowing for easier stacking or storage of multiple devices. In other cases, the circular disk may have a concave shape. A concave circular disk may conform more closely to the contour of typical food can lids, potentially providing enhanced coverage and stability during the lid removal process. The concave shape may also help to contain any liquids or contents that might otherwise spill when opening the can. The choice between a flat or concave circular disk may depend on factors such as the types of cans the device is designed to open, user preferences, and manufacturing considerations. In some implementations, the shape of the circular disk may influence the positioning and effectiveness of other components, such as the magnet or the wedge. For example, a concave circular disk may allow for a centrally placed magnet to sit closer to the can lid, potentially enhancing the magnetic attachment strength.

The device may be constructed using a combination of these materials. For example, a plastic base structure may be combined with silicone gripping surfaces or rubber components for specific functional areas. The combination of materials may allow for optimization of different properties throughout the device. The materials used in the construction of the device may be selected with food safety in mind. In many implementations, food-safe materials may be preferred to ensure that the device can be safely used in contact with food products. Food-safe materials may comply with relevant regulations and standards for food contact surfaces, potentially reducing the risk of contamination or chemical leaching during use. The specific choice and combination of materials may vary depending on factors such as manufacturing processes, cost considerations, and intended use scenarios. In some aspects, the material selection may influence properties such as the device's resistance to staining, ease of cleaning, and ability to withstand repeated use and washing cycles.

In some aspects, the tab slot may take various shapes to accommodate different styles of can tabs. The shape of the tab slot may influence how effectively the device engages with the lid tab during the opening process. In certain implementations, the tab slot may be elliptical in shape. An elliptical tab slot may provide a curved opening that can accommodate a range of tab sizes and shapes, potentially offering flexibility in engaging different types of can tabs.

In other cases, the tab slot may be square in shape. A square tab slot may provide a more defined engagement area for the lid tab, potentially offering precise alignment during the opening process. The corners of a square tab slot may be rounded in some implementations to prevent snagging or damage to the lid tab.

Alternatively, the tab slot may be rectangular in shape. A rectangular tab slot may offer an elongated opening that could accommodate longer lid tabs or provide additional space for maneuvering during the opening process. The length and width of a rectangular tab slot may be varied to suit different can tab designs.

The specific shape chosen for the tab slot may depend on factors such as the types of cans the device is designed to open, user preferences for ease of use, and manufacturing considerations. In some implementations, the edges of the tab slot, regardless of its shape, may be smoothed or beveled to facilitate easy insertion and removal of the lid tab while reducing the risk of damage to the tab or injury to the user.

The dimensions of the tab slot may be tailored to provide sufficient engagement with the lid tab while allowing for easy insertion and removal. In some cases, the size of the tab slot may be designed to accommodate a range of tab sizes commonly found on food cans, potentially enhancing the versatility of the device.

In some aspects, the wedge may be designed as a lifting feature with a tapered slope. The slope of the wedge may extend from a thin front edge to a thicker back edge. This tapered design may allow for easier insertion of the wedge under the lid tab of a food can. As the device is rotated, the gradually increasing thickness of the wedge may provide a progressive lifting force to the lid tab.

The angle and length of the wedge's slope may vary in different implementations. In some cases, a steeper slope may be used to provide more rapid lifting action, while in other cases, a gentler slope may offer more gradual and controlled lifting. The specific angle may be optimized for different types of can tabs and lid designs.

The thin front edge of the wedge may be designed to easily slip under the lid tab. In some implementations, this edge may be slightly rounded or beveled to further facilitate insertion. The thicker back edge may provide the maximum lifting height for the tab. The transition between the front and back edges may be smooth and continuous in some aspects, while in others, it may incorporate subtle contours or steps to influence the lifting dynamics.

The surface of any portion or the device including the wedge slope may incorporate small ridges, grooves, or textures to enhance grip on the lid tab as it is being lifted. The texture on the cylindrical wall or circular disk may also aid the user in gripping the cylindrical wall or cylindrical disk. These surface features may be designed to work in conjunction with the overall slope to guide the tab upward and away from the can lid. The material composition of the wedge may be selected to optimize its performance as a lifting feature. The wedge may be constructed from materials that offer a balance of rigidity and flexibility, allowing it to maintain its shape while conforming slightly to the contours of different lid tabs. The dimensions of the wedge, including its overall length, width, and height difference between the front and back edges, may be tailored to accommodate a range of food can sizes and tab designs. In some aspects, these dimensions may be adjustable or customizable to enhance the versatility of the device.

According to another aspect of the present disclosure, a method of using a device for removing a scored portion of a lid of a food can is provided. The method includes sliding a narrow portion of a wedge under the tab of the food can and rotating the device about a lid connection of the tab until a seal breaks between a scored portion of the lid and surrounding portion of the lid. The method also includes engaging a tab slot of the device with the tab of the food can wherein a circular disk covers the scored lid. The method further includes pulling the tab until the lid is removed from the food can and removing the scored lid from the scored lid removing device.

The method of securing the magnet to the circular disk may differ across implementations. In some cases, the magnet may be fully encapsulated within the material of the circular disk, protecting it from direct contact with food or liquids. Alternatively, the magnet may be partially exposed on the surface of the circular disk, potentially increasing its magnetic strength but requiring additional considerations for food safety and cleaning.

Another aspect of the invention is directed to a method of using the device. The method includes sliding a narrow portion of the wedge under the tab of the food can and rotating the device about a lid connection of the tab until a seal breaks between a scored portion of the lid and surrounding portion of the lid. The method includes engaging the tab slot of the device with the tab of the food can wherein the circular disk covers the scored lid, pulling the tab until the lid is removed from the food can and removing the scored lid from the scored lid removing device.

Another aspect of the invention is directed to a kit having a plurality of the scored lid removing devices. Each scored lid removing device includes a circular disk having a disk edge and a tab slot for engaging a lid tab disposed on the lid when the lid tab is in an extended position. Each scored lid removing device includes a cylindrical wall extending perpendicular from the disk edge, the cylindrical wall for engaging a food can rim, a wedge disposed on a portion of the circular disk along the cylindrical wall, the wedge for rotating a lid tab distal end away from a scored portion of lid of a food can and a magnet for removably securing the scored lid to the circular disk. Each of the plurality of scored lid removing devices is sized differently than every other scored lid removing devices in the kit.

The dimensions of the circular disk may be tailored to accommodate a range of food can sizes. In some aspects, the diameter of the circular disk may be slightly larger than standard food can diameters to ensure proper coverage and engagement with the can rim. The thickness of the disk may vary depending on factors such as material strength and the integration of other components.

It is an object of the present invention to provide a food can opening device which prevents splattering of the can contents as the scored lid is removed.

It is yet another object of the present invention to provide a food can opening device which allows easy rotation of a food container tab.

Still other objects and advantages of the invention will in part be obvious and will in part be apparent from the specification.

The above and other objects, which will be apparent to those skilled in the art, are achieved in the present invention which is directed to a device for opening scored lids of food cans, the device including a cylindrical wall. The cylindrical wall includes an upper wall support ring and a lower wall guide. The lower wall guide engages a food can rim. The device includes a circular disk extending within the cylindrical wall between the lower wall guide and upper wall support ring. The circular disk prevents liquid dispersion or splattering and possible hand lacerations as a scored lid is removed from a food can. The device includes a wedge or ramp portion disposed on a portion of the lower wall guide. The wedge portion is for rotating a lid tab distal end away from the scored lid of the food can. The device includes a tab slot disposed in the circular disk for engaging the lid tab when the lid tab is in an extended position. The device includes a lid holder for removably securing the scored lid to the circular disk.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a top perspective view of the scored lid remover according to the present invention;

FIG. 2A is a top perspective view of the scored lid remover with alternate features including supports and ribs in a partial cutaway view of the cylindrical wall;

FIG. 2B is a top perspective view of the scored lid remover showing an embodiment of the wedge having a depth the same as the cylindrical wall thickness;

FIG. 3A is a cross-sectional view of the scored lid remover along cut lines 3-3 shown in FIG. 2;

FIG. 3B is a cross-sectional view of the scored lid remover having the magnet on the upper portion of the cylindrical disk;

FIG. 3C is a cross-sectional view of the scored lid remover having the magnet embedded in the circular disk;

FIG. 4 is a top plan view of the scored lid remover shown in FIG. 1;

FIG. 5 is a bottom plan view of the scored lid remover shown in FIG. 1;

FIG. 6 is a front perspective view of a first step of a method for removing the scored lid of a food can;

FIG. 7 is a front perspective view of a second step of a method for removing the scored lid of a food can;

FIG. 8 is a front perspective view of a third step of a method for removing the scored lid of a food can;

FIG. 9 is a front perspective view of a fourth step of a method for removing the scored lid of a food can;

FIG. 10 is a front perspective view of a second method of using the scored lid remover for rotating the tab of a food can;

FIG. 11 is a bottom plan view of a second embodiment of the scored lid remover having a tab securing pocket;

FIG. 12 is a bottom plan view of a third embodiment of the scored lid remover having non-circular perimeter wall;

FIG. 13 shows a kit for removing scored lids from various sized food cans;

FIG. 14 shows a partial cross-sectional view of one embodiment of the magnet embedded in the circular disk;

FIG. 15 shows a partial cross-sectional view of another embodiment of the magnet embedded in the circular disk;

FIG. 16 shows a top plan view of the embodiment of the magnet embedded in the circular disk shown FIG. 15;

FIG. 17 shows a bottom plan view of the embodiment of the magnet embedded in the circular disk shown FIG. 15; and

FIG. 18 shows a bottom plan view of an embodiment of the device having texture on the wedge and on the circular disk.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The device has a ramp portion along the bottom circumferential wall to help lift the

tab upwards so that the user can more easily move the tab to a vertical position. The user slides the device's lifting portion which is about two inches wide and currently metal but could be strong silicone or plastic that is edged under the pull tab. The user then lifts the device up.

The device can also be tilted back on an angle, which is intuitive. This will distance the tab from the surface of the can.

Next, the user turns the device over and threads the pull tab through the device slit opening. Effectively, this is a lid over lid concept. The device will click right onto most pull tab lids as the embedded magnet engages. The user proceeds to pull the lid off as usual. The lid stays contained within the device and easily disengages when the user pushes back down on the threaded tab. The lid will fluidly drop from the magnetized position into a sink or receptacle. The addition of magnets, a suction mechanism, or other lid securing mechanisms could be incorporated.

There is a bumper around the perimeter of the device for leverage. This offers a sturdier edge when lifting the pull tab up and gives the user greater grip overall. The device to be manufactured from a very rigid silicone that has some slight give. It should be dishwasher safe. The magnet is centered and embedded in the silicone. The magnet may be a single disk if it's strong enough or multiple magnets. It's possible the magnet could have some depth and create a slight bump on the inner side.

The lifting feature is optional to use. Some may have an easier time getting the pull tab started on their own and not need to use this feature. The lifting feature is for individuals who currently rely on butter knives or screwdrivers to lift the pull tab or who struggle with this initial step and for those who want an all-in-one tool. The device is effective even when there are ridges on the can. The device works best with circular lids and are made of steel rather than aluminum, but even with aluminum lids the device still works to protect the hand but may not fully magnetize to the lid. The majority of consumer cans have steel lids.

The device serves as a protective guard during the lift and pull process. The device makes removing a lid a safer process so that the sharp edges of a pull tab top do not graze or injure the hand. The device helps the user to feel more confident pulling past the point of resistance. The device keeps the hands clean. The device serves as a barrier to the food can, the food can contents and the scored portion of the food can lid. Although the lifting of the tab beaks the seal and allows a ring to be accessible to grab and pull, there is still a second breaking resistance to go beyond the point of the seal breakage. The second breaking resistance requires additional pulling force and, without the device, makes the user weary of pulling the tab. The device provides confidence for a user to pull past the point of resistance, which is often where a lid gets stuck.

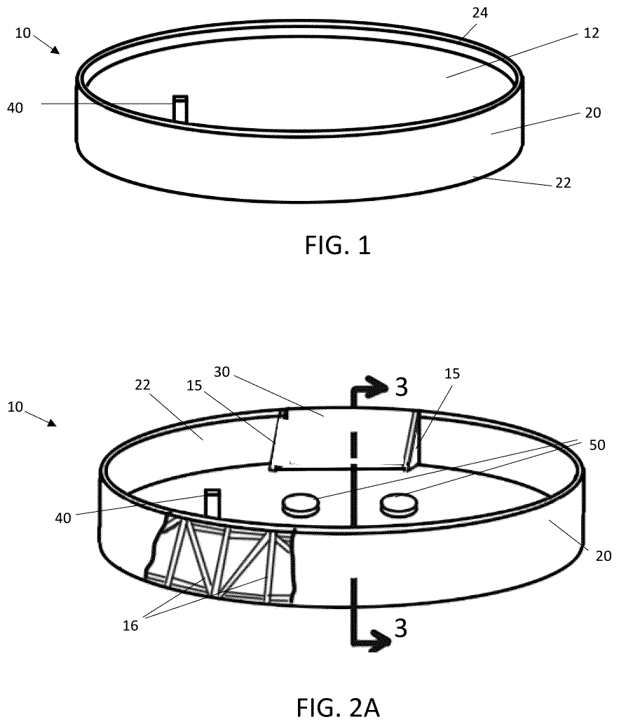

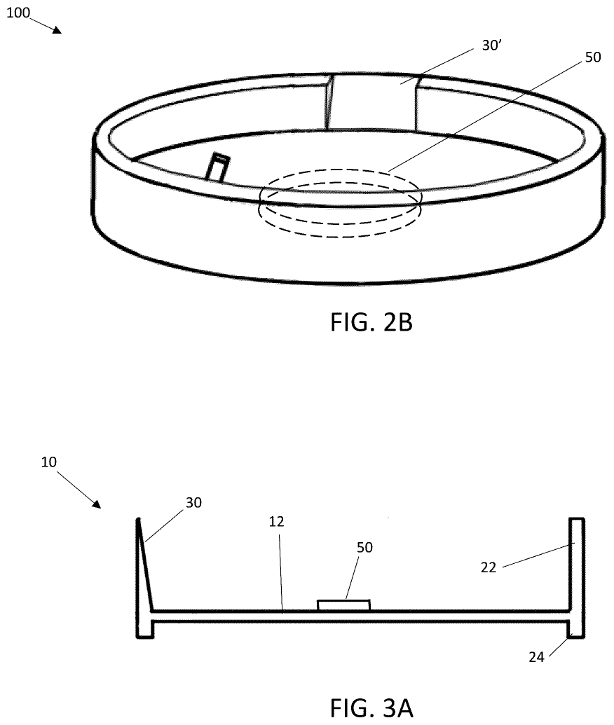

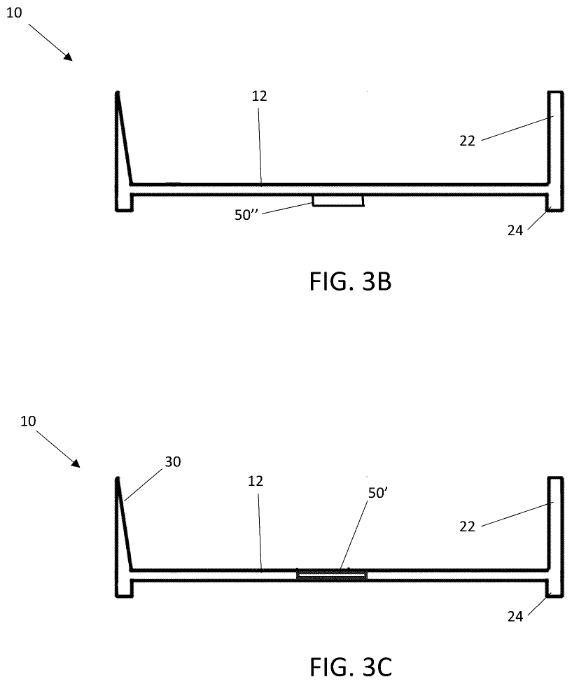

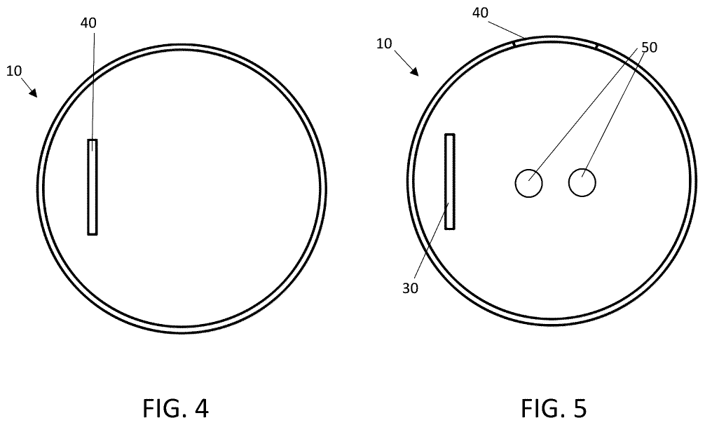

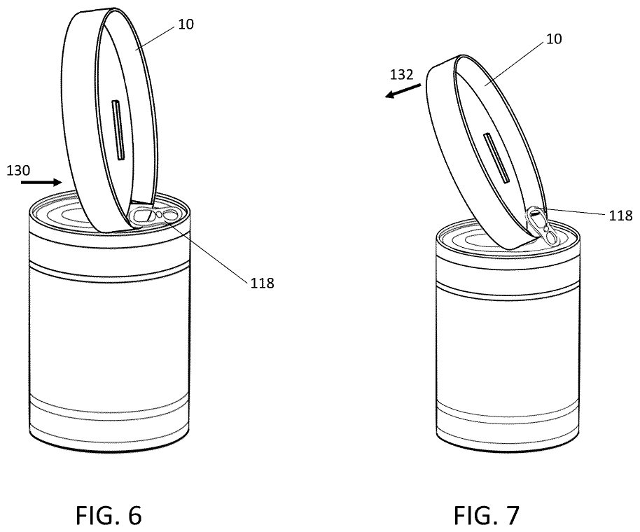

Referring now to the drawings FIG. 1-18, and more particularly to FIGS. 1-5, there is shown a device for opening scored lids of food cans. The device is a scored lid remover 10 having a cylindrical wall 20. The cylindrical wall 20 includes an upper wall support ring 24 and a lower wall guide 22. The lower wall guide 22 engages a food can rim 110. The scored lid remover 10 includes a circular disk 12 or splatter guard extending within the cylindrical wall 20 between the lower wall guide 22 and upper wall support ring 24. The circular disk 12 prevents liquid dispersion or splattering and hand lacerations as a scored lid 114 is removed from a food can 100 along the lid score 112 or tear line. The scored lid remover 10 includes a wedge 30 or ramp portion disposed on a portion of the lower wall guide 22. The wedge portion 30 is for rotating a distal end of lid tab 118 away from the scored lid 112 of the food can. The scored lid remover 10 includes a tab slot 40 disposed in the circular disk 12 for engaging the lid tab 118 when the lid tab 118 is in an extended position. The tab slot 40 is positioned 90 degrees from the tab slot 40 in the embodiment of FIGS. 1-5 although the tab slot 40 may be located at any position along the cylindrical wall 20. When the tab slot 40 is positioned directly across from the wedge 30, the scored lid remover 10 is simply flipped to transition from using the wedge 30 to using the tab slot 40. The scored lid remover 10 includes a lid holder for removably securing the scored lid 112 to the circular disk 12. The rib holder shown in FIG. 3A is a magnet 50 secured to the bottom surface of the circular disk 12 although the magnet 50 may be secured to the upper surface of the circular disk 12. FIG. 5 also shows alternate embodiments of reinforcement including supports 15 or ribs 16. The rib holder shown in FIG. 3B is a magnet 50′ embedded in the circular disk 12 and may be installed while forming of the device during manufacture or may be inserted in an opening in the circular disk, secured by a press fit or by an opening cover. The ribs 16 are shown in a partial cutaway of the surface material, the ribs 16 are embedded in the silicone or other material. The supports 15 are most beneficial adjacent the wedge 30 and the ribs 15 may be in the entire cylindrical wall 20 as shown in the diagram, but are most beneficial adjacent the wedge 30. The ribs 16 may alternately be place on the inside surface of the cylindrical wall rather than embedded in the cylindrical wall material. FIG. 6 also shows the supports 15 although they may be left off when supporting the cylindrical with the ribs or if the cylindrical wall is sufficiently stiff without additional features.

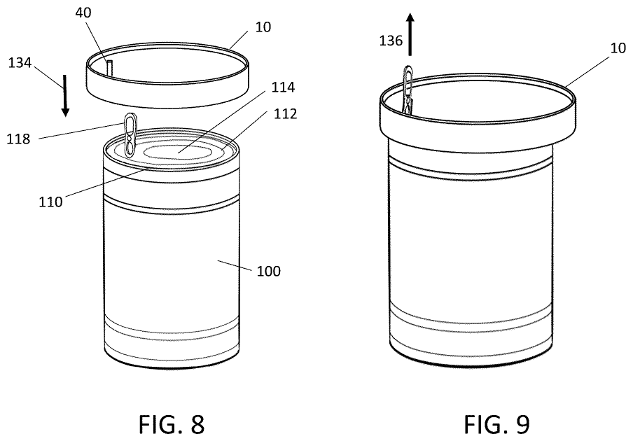

FIGS. 6-9 show a method for using the scored lid remover 10. The scored lid remover 10 is placed in a vertical position whereby the wedge 30 is slid under the tab 118 (FIG. 6) in the direction of arrow 130. The scored lid remover 10 is rotated in the direction of arrow 132 for extending the can tab 118 in the vertical position (FIG. 7). The scored lid remover 10 is positioned above the food can rim 110 with the tab slot 40 aligned with the extended tab 118. The scored lid remover 10 is placed on the food can 100 in the direction of arrow 134, engaging the food can rim 110 (FIG. 8). Magnets 50 engage the can lid so the lid remains secured to the scored lid remover 10 during lid removal. The tab 118 and scored lid remover 10 are urged upward in the direction of arrow 136 until the seal is broken and the scored lid 114 is removed (FIG. 9). The disk 12 prevents splattering or dispersion of the can contents and guards the hand against possible injury. The scored lid remover 10 and attached scored lid are placed above a disposal area and the tab 188 is pushed until the scored lid 114 disengages from the magnets 50. Alternately, as shown in the embodiment of FIG. 11, the securing mechanism is a suction cup 52.

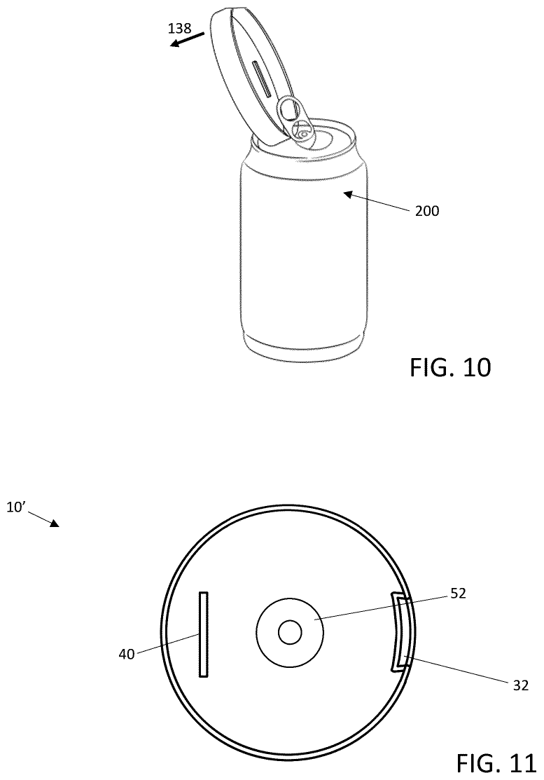

FIG. 10 is a front perspective view of a second method of using the scored lid remover 10 for rotating the tab of a food or beverage can such as a soda can 200 or soup can in the direction of arrow 138.

FIG. 11 is a bottom plan view of a second embodiment of the scored lid remover having a tab securing pocket 32. The tab securing pocket 32 prevents the food can tab 118 from slipping from the wedge 30 during rotating of the tab 118. The tab securing pocket 32 is positioned directly across from the tab slot 40 although the tab securing pocket 32 may be located at any position along the cylindrical wall 20.

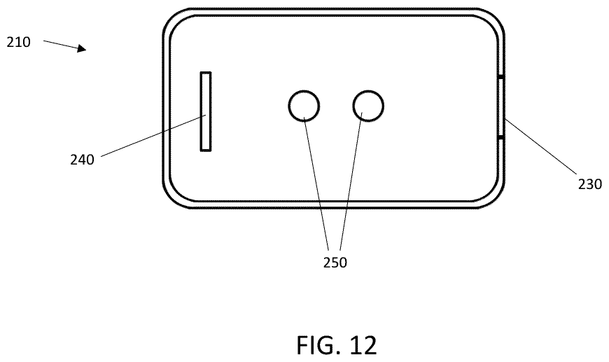

In another embodiment shown in FIG. 12, the present invention is a scored lid remover 210 having a perimeter wall 220 which may include any shape perimeter including the square perimeter wall shown in FIG. 12. The scored lid remover 210 may be used for removing scored lids of non-circular or other irregular shaped can. The perimeter wall 220 includes an upper wall support 224 and a lower wall guide 222. The lower wall guide 222 engages a food can rim 110. The scored lid remover 210 includes a splatter guard 212 extending within the perimeter wall 220 between the lower wall guide 222 and upper wall support 224. The splatter guard 212 prevents liquid dispersion or splattering as a scored lid 114 is removed from a food can 100 along the lid score 112 or tear line. The scored lid remover 210 includes a wedge 230 or ramp portion disposed on a portion of the lower wall guide 222. The wedge portion 230 is for rotating a distal end of lid tab 118 away from the scored lid 112 of the food can. The scored lid remover 210 includes a tab slot 240 disposed in the splatter guard 212 for engaging the lid tab 118 when the lid tab 118 is in an extended position. The scored lid remover 210 includes a lid holder for removably securing the scored lid 112 to the splatter guard 212.

The slot may be in the shape of a coin slot, an ellipsis, a square, rectangle and or/any shape that accepts pull-tabs. The slit can be of a range of dimensions in its opening.

The wedge has a front edge of one thickness and a thicker back edge so the wedge has a slope that tapers from thin front edge to back edge. This slope can have any increasing durometer measurement that facilitates and results in lifting of the pull tab.

The magnet may be fully molded in or somewhat exposed. The lid material may be plastic, nylon, silicone, rubber or any combination thereof. And is preferably a food safe material.

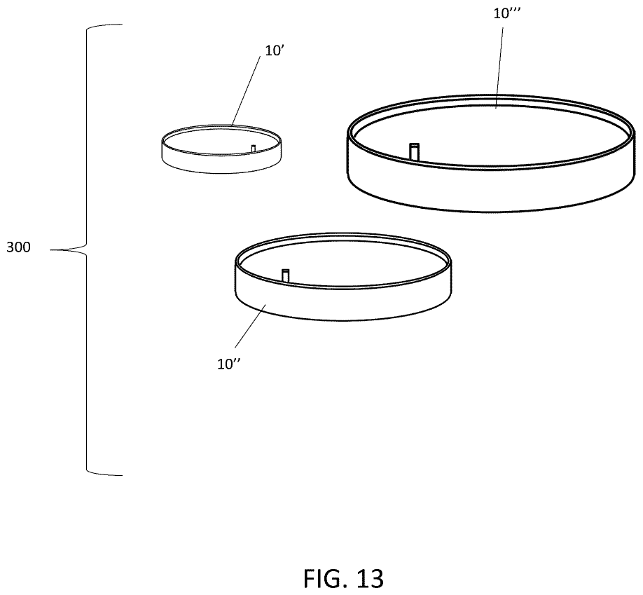

FIG. 13 shows a kit 500 for removing scored lids from various sized food cans. The kit 500 includes a plurality of various sized scored lid removing devices 10′, 10″, 10′″.

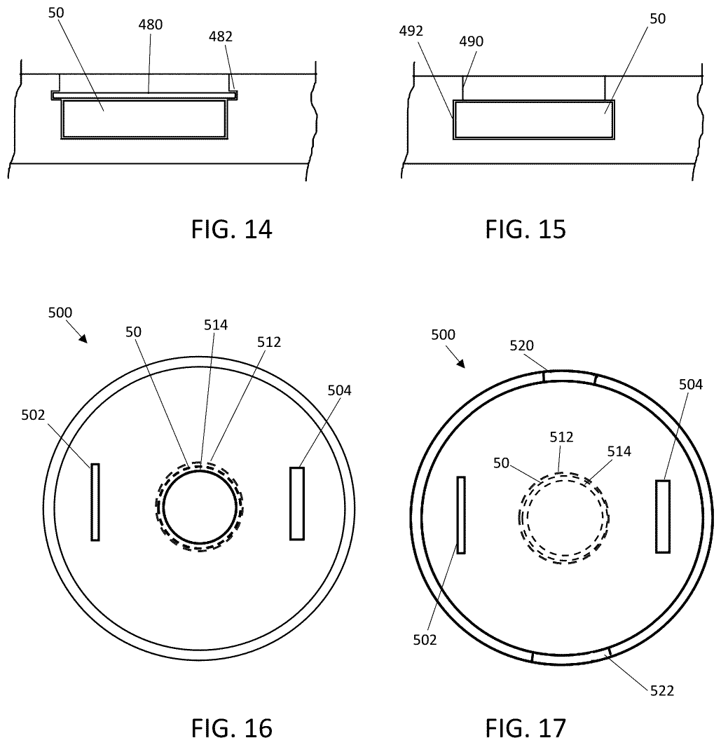

FIG. 14 shows a partial cross-sectional view of one embodiment of the magnet embedded in the circular disk. The magnet 50 is embedded in a cavity in the circular disk, the cavity including a groove 482 for engaging a magnet cover 480 for sealing the magnet in the circular disk. The magnet 50 and magnet cover 480 may be installed permanently during manufacture or the magnet cover 480 may be removable in order to access the magnet 50.

FIG. 15 shows a partial cross-sectional view of another embodiment of the magnet embedded in the circular disk. The magnet 50 is press fit into a cavity 492 through opening 490. Opening 490 is sized slightly smaller than the magnet in order to hold the magnet within the cavity. The opening edges are pliable enough to be able to force the magnet into the cavity but resilient enough so the magnet is not releasable from the cavity once inserted.

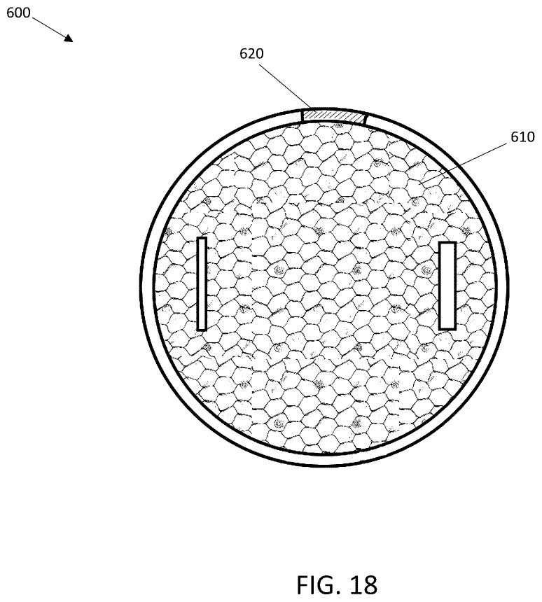

FIG. 16 shows a top plan view and FIG. 17 shows a bottom plan view of the device using the magnet cavity of FIG. 15. The circular disk includes a plurality of tab slots 502,504 to accommodate different sized tabs. The circular disk also includes a plurality of different sized wedges 520, 522 which may differ both in thickness and in slope angle. The magnet 50 in cavity 512 can be visually seen through opening 514 in the bottom view and the magnet 50 is shown in hidden lines in the top view of FIG. 17. FIG. 18 shows a bottom plan view of an embodiment of the device 600 having texture on the wedge and on the circular disk. The texture may be on any portion of the device and may include different textures on different portions as shown in the wedge texture 620 and the circular disk texture 610 of FIG. 18.

The scored lid remover may include any combination of features described. The number of wedges, magnets and tab slots may also be of any combination. The configuration of the wedges, magnets and tab slots may also be of any combination. The cylindrical wall may be rounded at the top rim, may be square at the top rim, or may have any symmetrical or asymmetrical contour.

Another aspect of the invention as shown in FIGS. 1, 2, 3A, 3B, 4 and 5 is a scored lid removing device for removing a scored portion of a lid from a food can. The device 10 includes a circular disk 12 having a disk edge and a tab slot 40 for engaging a lid tab disposed on the lid of the food can when the lid tab is in an extended position and a cylindrical wall 20 extending perpendicular from the disk edge, the cylindrical wall 20 for engaging a food can rim. The device 10 included a wedge 30 disposed on a portion of the circular disk 12 along the cylindrical wall 20, the wedge 30 for rotating a lid tab distal end away from a scored portion of lid of a food can. The device includes a magnet 50 for removably securing the scored lid to the circular disk. The wedge 30 may be integrated with the cylindrical wall 20. The device has a perimeter 24 extending the cylindrical wall 20 in the opposite direction from the circular disk as perimeter 22. The magnet 50 may be positioned centrally on the circular disk. The lid may be flat or concave. The magnet 50 may be encapsulated from top or underside of the lid. The magnet 50 may be partially exposed. The lid material may be plastic, nylon, silicone, rubber or any combination thereof. The lid material is preferably food safe. The device 10 may include ribs 16 for strengthening a connection between the circular disk to the cylindrical wall. The tab slot may be an ellipsis, a square or rectangle. The wedge may be a lifting feature section has a slope that tapers from thin front edge to back edge.

Another aspect of the invention is directed to a method of using the device. The method includes sliding a narrow portion of the wedge under the tab of the food can and rotating the device about a lid connection of the tab until a seal breaks between a scored portion of the lid and surrounding portion of the lid. The method includes engaging the tab slot of the device with the tab of the food can wherein the circular disk covers the scored lid, pulling the tab until the lid is removed from the food can and removing the scored lid from the scored lid removing device.

Another aspect of the invention as shown in FIG. 13 is directed to a kit having a plurality of the scored lid removing devices. Each scored lid removing device includes a circular disk having a disk edge and a tab slot for engaging a lid tab disposed on the lid when the lid tab is in an extended position. Each scored lid removing device includes a cylindrical wall extending perpendicular from the disk edge, the cylindrical wall for engaging a food can rim, a wedge disposed on a portion of the circular disk along the cylindrical wall, the wedge for rotating a lid tab distal end away from a scored portion of lid of a food can and a magnet for removably securing the scored lid to the circular disk. Each of the plurality of scored lid removing devices is sized differently than every other scored lid removing devices in the kit.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A device for removing a scored portion of a food can lid, the device comprising:
a circular disk having a disk edge and a tab slot on the circular disk, the tab slot for engaging a lid tab disposed on the food can lid when the lid tab is in an extended position;
a cylindrical wall extending perpendicular from the disk edge, the cylindrical wall for engaging a food can rim;
a wedge disposed on a portion of the circular disk along the cylindrical wall, the wedge for rotating a lid tab distal end away from the scored portion of the food can lid of the food can; and
a magnet for removably securing the scored portion to the circular disk.

2. The device of claim 1 wherein the wedge is integrated with the cylindrical wall.

3. The device of claim 1 wherein the circular disk has a perimeter extending in an opposite direction from the cylindrical wall.

4. The device of claim 1 wherein the magnet is positioned centrally on the circular disk.

5. The device of claim 1 wherein the circular disk is concave.

6. The device of claim 1 wherein the magnet is encapsulated from a top or from an underside of the circular disk.

7. The device of claim 1 wherein the magnet is partially exposed.

8. The device of claim 1 manufactured in a plastic, nylon, silicone or rubber material, or any combination thereof.

9. The device of claim 8 wherein the material is food safe.

10. The device of claim 1 including ribs for strengthening a connection between the circular disk to the cylindrical wall.

11. The device of claim 1 wherein the tab slot is an ellipsis, a square or a rectangle.

12. The device of claim 1 wherein the wedge is a lifting feature section having a slope that tapers from a thin front edge to a wall back edge.

13. A method of using the device of claim 1 comprising;
providing the device and the food can having a scored lid;
sliding a narrow portion of the wedge under the tab of the food can;
rotating the device about a lid connection of the tab until a seal breaks between a scored portion of the lid and surrounding portion of the lid;
engaging the tab slot of the device with the tab of the food can wherein the circular disk covers the scored lid;
pulling the tab until the lid is removed from the food can; and
removing the scored lid from the scored lid removing device.

14. A kit having a plurality of scored lid removing devices, each scored lid removing device comprising:
a circular disk having a disk edge and a tab slot on the circular disk, the tab slot for engaging a lid tab disposed on the lid when the lid tab is in an extended position;
a cylindrical wall extending perpendicular from the disk edge, the cylindrical wall for engaging a food can rim;
a wedge disposed on a portion of the circular disk along the cylindrical wall, the wedge for rotating a lid tab distal end away from the scored portion of the lid of the food can; and
a magnet for removably securing the scored lid to the circular disk;
wherein each of the plurality of scored lid removing devices is sized differently than every other scored lid removing devices in the kit.

15. The kit of claim 14 wherein the wedges are integrated with the cylindrical wall adjacent the wedge.

16. The kit of claim 14 wherein each of the circular disks have a perimeter extending beyond the cylindrical wall.

17. The kit of claim 14 wherein the magnet of each scored lid removing device is positioned centrally on the circular disk.

18. The kit of claim 14 wherein the lids are concave.

19. The kit of claim 14 wherein the magnets are encapsulated from a top or from an underside of the circular disk.
